(19) United States
(12) Patent Application Publication
(10) Pub. No.: US 2012/0019589 A1
(43) Pub. Date: Jan. 26, 2012

(54) HARD IMAGING DEVICES AND HARD IMAGING METHOD

(76) Inventors: Omer Gila, Cupertino, CA (US); Napoleon J. Leoni, San Jose, CA (US); Michael H. Lee, San Jose, CA (US)

(21) Appl. No.: 13/262,605

(22) PCT Filed: Apr. 1, 2009
(86) PCT No.: PCT/US2009/039150

§ 371 Date: Sep. 30, 2011

(51) Int. Cl. B41J 2/165

(52) U.S. Cl. 347/22

(57) ABSTRACT

Hard imaging devices and methods are described. According to one arrangement, a hard imaging device includes a media transport system configured to move media along a media path and a print device adjacent to the media path and configured to eject a plurality of droplets of a liquid marking agent in a direction towards the media moving along the media path to form hard images using the media. The ejection of the droplets of the liquid marking agent by the print device creates satellites of the liquid marking agent suspended in air in a region adjacent to the print device and the media. The device also includes a satellite removal system in one arrangement to remove the satellites from the air in the region adjacent to the print device and the media.

### FIELD OF THE DISCLOSURE

Aspects of the disclosure relate to hard imaging devices and hard imaging methods.

### BACKGROUND

Imaging devices capable of printing images upon paper and other media are ubiquitous and used in many applications including monochrome and color applications. The use and popularity of these devices continues to increase as consumers at the office and home have increased their reliance upon electronic and digital devices, such as computers, digital cameras, telecommunications equipment, etc.

A variety of methods of forming hard images upon media exist and are used in various applications and environments, such as home, the workplace and commercial printing establishments. Some examples of devices capable of providing different types of printing include laser printers, impact printers, inkjet printers, commercial digital presses, etc.

Some configurations of printers which use liquid marking agents may be subjected to contamination by satellites formed during printing operations. For example, in some inkjet configurations, the jetting of drops of a liquid marking agent may also result in the formation of satellites of the liquid marking agent which may contaminate media being imaged upon, nozzles, or other equipment of the printer.

### DESCRIPTION OF DRAWINGS

At least some aspects of the disclosure are directed towards improved imaging methods and apparatus.

FIG. 1 is a functional block diagram at a hard imaging device according to one embodiment.

FIG. 2 is an illustrative representation of a print device according one embodiment.

FIG. 3 is an illustrative representation of a print device according one embodiment.

FIG. 4 is an illustrative representation of a print device according one embodiment.

FIG. 5 is an illustrative representation of a print bar according one embodiment.

### DETAILED DESCRIPTION

Hard imaging devices, such as printers, may be subjected to contamination during imaging operations. For example, some printer inkjet configurations eject droplets of a liquid marking agent (e.g., ink) to form hard images upon media. The ejection of the droplets may result in the creation of satellites of the liquid marking agent which may contaminate media being imaged upon or imaging components of the hard imaging devices. This contamination may degrade the print quality of the hard imaging device. At least some aspects of the disclosure are directed towards methods and apparatus configured to reduce contamination caused by satellites of the liquid marking agent.

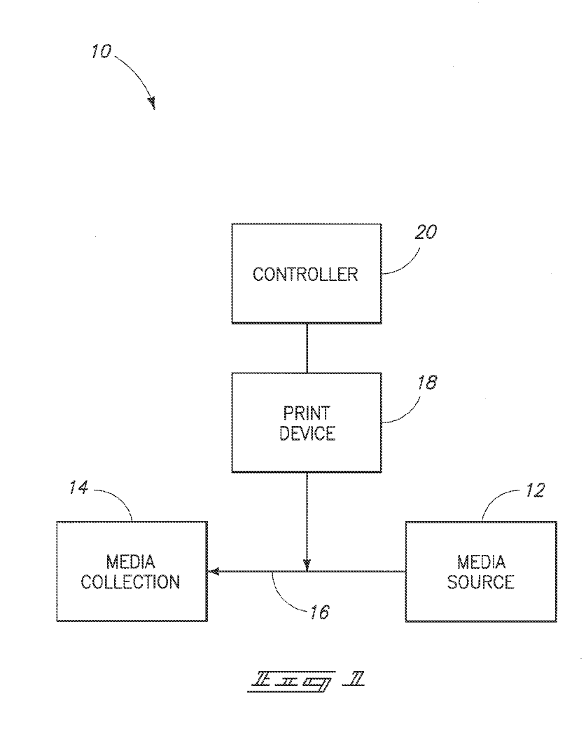

Referring to FIG. 1, an example of a hard imaging device 10 arranged according to one embodiment of the disclosure is shown. Hard imaging device 10 is configured to form hard images upon media. Example embodiments of the hard imaging device 10 include printers although other hard imaging device configurations are possible including copiers, multiple-function devices, or other arrangements configured to form hard images upon media.

The depicted embodiment of hard imaging device 10 includes a media source 12, a media collection 14, a media path 16, a print device 18 and a controller 20. Other embodiments of hard imaging device 10 are possible and include more, less or additional components.

In one embodiment, media source 12 comprises a supply of media to be used to form hard images. For example, media source 12 may be configured as a roll of web media or a tray of sheet media, such as paper. Other media or configurations of media source 12 may be used in other embodiments.

Media travels in a process direction along the media path 16 from media source 12 to media collection 14 in example embodiments. Hard images are formed using media travelling along the media path 16 intermediate the media source 12 and media collection 14 in example configurations described below.

Media collection 14 is configured to receive the media having hard images formed thereon following printing. Media collection 14 may be configured as a take-up reel to receive web media or a tray to receive sheet media in example embodiments.

Media source 12 and media collection 14 may form a media transport system in one embodiment of hard imaging device 10 (e.g., comprising supply and take-up reels for web media) configured to move the media along the media path 16. In another embodiment of hard imaging device 10 (e.g., sheet media), the media transport system may comprise a plurality of rollers (not shown) to move media from media source 12 to media collection 14.

Print device 18 is configured to provide one or more liquid marking agents to media travelling along media path 16 to form the hard images in one embodiment. In one embodiment, the liquid marking agents may include one or more colors of inks. Different types of inks, such as aqueous, solvent or oil based, may be used depending upon the configuration of the hard imaging device 10. Furthermore, the liquid marking agents may include a fixer or binder, such as a polymer, to assist with binding inks to the media and reducing penetration of the inks into the media. In one embodiment, print device 18 comprises an inkjet print head (e.g., piezo, thermal, etc.) configured to eject a plurality of droplets of the liquid marking agent corresponding to an image to be formed. Hard imaging device 10 may be configured to generate color hard images in one embodiment, and print device 18 may include a plurality of pens (not shown in FIG. 1) configured to provide droplets of the liquid marking agent having different colors (e.g., different colored inks) and fixers or binders (if utilized). Other arrangements of print device 18 are possible.

In one embodiment, controller 20 is arranged to process data (e.g., access and process digital image data corresponding to a color image to be hard imaged upon media), control data access and storage, issue commands, monitor imaging operations and control imaging operations of hard imaging device 10. In one embodiment, controller 20 is arranged to control operations described herein with respect to removal of satellites of the liquid marking agent generated during imaging operations. In one arrangement, the controller 20 comprises circuitry configured to implement desired programming provided by appropriate media in at least one embodiment. For example, controller 20 may be implemented as one or more of a processor and/or other structure configured to execute executable instructions including, for example, software and/or firmware instructions, and/or hardware circuitry. Example embodiments of controller 20 include hardware logic, PGA, FPGA, ASIC, state machines, and/or other structures alone or in combination with a processor. These examples of controller 20 are for illustration and other configurations are possible.

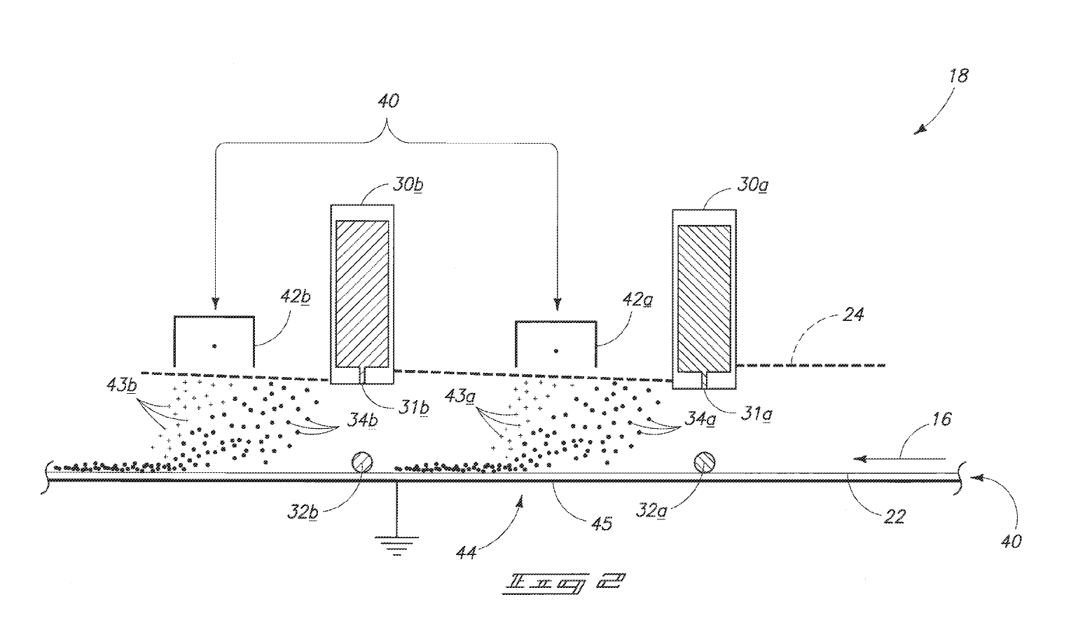

Referring to FIG. 2, one embodiment of print device 18 configured as an inkjet printhead configured to form color hard images is shown. The print device 18 is configured to form hard images upon media 22 travelling along media path 16 as shown. The movement of media 22 travelling along media path 16 generates an air boundary 24 generally corresponding to a boundary where air below the boundary 24 moves with the media 22 in the direction of travel of the media 22 along the media path 16 while air above the boundary 24 is not significantly affected by the travelling media 22.

Print device 18 includes a plurality of pens 30a, 30b in the depicted arrangement configured to form hard color images. Other arrangements of print device 18 include a single pen 30 configured to eject a marking agent having a single color for monochrome applications. Pens 30a, 30b include respective nozzles 31a, 31b which are configured to eject droplets 32a, 32b of the liquid marking agent toward media 22 moving along media path 16. In the described embodiment, pens 30a, 30b are configured to eject the droplets 32a, 32b comprising different colors of ink (e.g., cyan, magenta, yellow, or black). Print device 18 may include additional pens to eject droplets of marking agent of additional colors and/or fixers or binders in some embodiments.

In the depicted embodiment, the pens 30a, 30b are arranged in series one after another to eject the droplets 32a, 32b upon media 22 moving along paper path 16 to form color images in a single pass of the media 22 adjacent to print device 18. In other embodiments, the different colors may be deposited upon media 22 in a plurality of passes of the media 22 adjacent to the print device 18. In yet an additional embodiment, print device 18 only includes a single pen to form black and white images. In one embodiment, nozzles 31a, 31b are spaced a desired distance (e.g., 0.5 mm-1.0 mm) from media 22.

FIG. 2 shows droplets 32a, 32b of liquid marking agent upon media 22. The ejection of droplets 32a, 32b by pens 30a, 30b to form hard images upon media 22 generates plural satellites 34a, 34b of the respective different colors of the liquid marking agent. In particular, droplets 32a, 32b may individually have an elongated shape as they are ejected from nozzles 31a, 31b due to adhesion forces between the ejected liquid marking agent and the nozzles 31a, 31b. The heads of the droplets 32a, 32b may move at a faster rate away from pens 30a, 30b compared with the tail portions of the droplets 32a, 32b which may lose their initial speed breaking away from the droplets 32a, 32b and creating the satellites 34a, 34b. The satellites 34a, 34b are relatively small and light aerosol droplets compared with the ejected droplets 32a, 32b and may remain suspended in a region of air adjacent to media 22 and downstream of the pens 30a, 30b while droplets 32a, 32b continue to move downward to the media 22. In one embodiment, the droplets 32a, 32b individually have a diameter of approximately 12-50 microns and a volume between 1 to 50 pL while the satellites individually have a diameter of approximately 1-10 microns and a volume of approximately 0.01 to 0.3 These satellites 34a, 34b may land upon various components of the print head 18 of the hard imaging device 10 (such as pens 30a, 30b) and/or media 22. Satellites 34a, 34b landing upon the pens 30a, 30b or media 22 may degrade the print quality of hard images being formed upon media 22.

According to some embodiments described herein, hard imaging device 10 includes a satellite removal system 40 configured to remove the satellites 34a, 34b which are suspended in a region of air about pens 30a, 30b. In one embodiment, satellite removal system 40 is configured to generate a flux of charges providing an electric field to remove the satellites 34a, 34b. The satellites 34a, 34b are electrically charged by the flux of charges and the charged satellites 34a, 34b are directed away from the region of air about pens 30a, 30b by the electrical field in one embodiment.

Referring to the example arrangement shown in FIG. 2, the satellite removal system 40 includes a plurality of sources 42a, 42b configured to create the electrical field and a target 44. In the depicted embodiment, sources 42a, 42b may be referred to as charge injectors (e.g., coronas, Scorotrons, charge rollers, needles, edges) and are configured as positive charging devices which individually emit a stream of positively charged ions 43a, 43b to provide an electrical field, charge satellites 34a, 34b and direct the charged satellites 34a, 34b to target 44. Charge emitting portions of sources 42a, 42b are provided approximately 2-6 mm above the surface of media 22 in one embodiment. Charge emitting portions of sources 42a, 42b may be provided at substantially the same elevation as nozzles 31a, 31b in another embodiment (e.g., 0.5-1 mm above the surface of media 22).

In the illustrated example embodiment, target 44 is implemented as a grounded structure 45 configured to receive the emitted charged ions. In one embodiment, grounded structure 45 is implemented as a conductive plate adjacent to the media path 16 and media 22. In some arrangements, media 22 travelling along media path 16 is spaced from the grounded conductive plate (e.g., spaced by a distance of approximately 0.4 mm-1 mm) to avoid abrasion of media 22 and/or damage to images which may be formed on the lower surface of media 22 in FIG. 2. In another embodiment, the grounded structure 45 is implemented as a plurality of grounded conductive rollers (not shown) which contact and move with media 22 travelling along the media path 16. In one more specific example, the grounded conductive rollers are provided corresponding to respective ones of the pens 30a, 30b and are positioned in alignment with the pens 30a, 30b. Other configurations of target 44 are possible.

In the depicted embodiment, the positively charged ions emitted from sources 42a, 42b are attracted to target 44. While travelling along field lines intermediate the sources 42, 42b and target 44, the ions positively charge the satellites 34a, 34b which are subsequently attracted to the grounded target 44. The generated electrical field directs the electrically charged satellites 34a, 34b downward towards the target 44 and the satellites 34a, 34b and upon the media 22 as shown in FIG. 2 which operates to remove the satellites 34a, 34b which were suspended in air from an imaging region above the media 22 and adjacent to pens 30a, 30b. In illustrative examples, the sources 42a, 42b implemented as positive coronas have operational voltages of approximately 3 kV if the media 22 contacts the target 44 and approximately 5-8 kV if the media 22 is spaced approximately 0.5-1.0 mm from the target 44. Other arrangements are possible.

As discussed above in one embodiment, the sources 42a, 42b are configured to emit streams of positively-charged ions which are attracted to the grounded target 44. Sources 42a, 42b may be configured to emit negatively charged ions and target 44 may be provided at a positive voltage to attract the negatively charged ions and satellites 34a, 34b charged thereby in another embodiment.

In one embodiment using negatively charged ions, an ozone removal system (not shown) may be used to remove ozone generated during the emission of the negative ions from sources 42a, 42b (e.g., using suction to remove the ozone). Typical charge fluxes of sources 42a, 42b implemented as negative coronas provide approximately 10¹² electrons per cm² of the media 22 for a typical process speed of print device 18 of approximately 1˜2 m/s compared with approximately 40% of the number for positive coronas. Use of negative coronas provides charging of an individual satellite 34a, 34b with approximately 10,000 e. However, positive coronas provide charges of increased uniformity compared with negative coronas. In one arrangement, sources 42a, 42b configured as coronas individually have a current of approximately 2 mA/meter and about 16 watts/meter of width.

The velocity of ions (˜10̂3 mils) emitted by sources 42a, 42b is large compared with air speed corresponding to the movement of media 22 along path 16 (e.g., 1˜2 m/s) and velocity of ejected droplets 32a, 32b (approximately 10⁵ cm/s). This provides a velocity of charged satellites 34a, 34b of approximately 10 m/s when a negative corona is used or 4 m/s if a positive corona is used. For satellites 34a, 34b having a diameter of approximately 1 micron, the ratio of achieved electrostatic forces on the satellites 34a, 34b compared to air drag forces is approximately 10 for a negative corona and approximately 4 for a positive corona providing quick removal of satellites 34a, 34b from the air region about the pens 30a, 30b.

In this example embodiment, satellite removal system 40 is configured to reduce cross-contamination between pens 30a, 30b. For example, source 42a is configured to emit the charged ions 43a to charge and remove satellites 42a from the region of air intermediate the pens 30a, 30b and before the satellites 42a can contaminate pen 30b downstream from pen 30a.

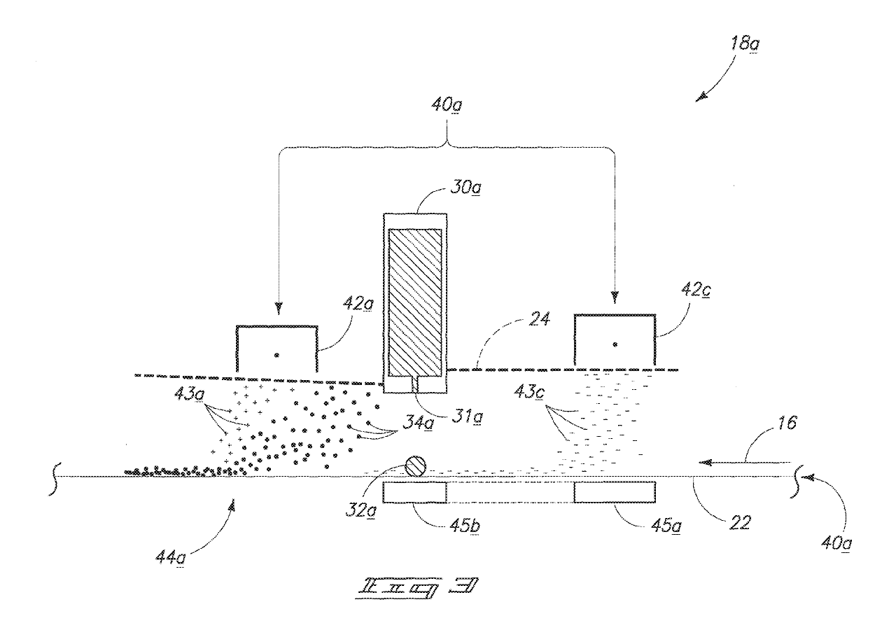

Referring to FIG. 3, another embodiment of print device 18a is shown. Print device 18a includes another embodiment of satellite removal system 40a configured to remove satellites 34a suspended in the air and resulting from the ejection of droplets 32a from nozzle 31a. Additional pens to provide droplets of liquid marking agent are not shown in FIG. 3 but may be provided in some arrangements.

In the illustrated embodiment, satellite removal system 40a comprises another source 42c in addition to source 42a. Source 42c has a polarity opposite to the polarity of source 42a and is configured to provide an electrical field with respect to a grounded structure 45a to electrically charge media 22 travelling along the media path 16. In one example, source 42c is configured to emit negatively charged ions which negatively charge media 22 providing target 44a which attracts satellites 34a which have been positively charged by positively charged ions 43a emitted from source 42a. As shown in FIG. 3, a portion of the media 22 is initially negatively charged by source 42c prior to movement of the portion of media 22 below source 42a. The positively charged satellites 34a are attracted to the target 44a comprising negatively-charged media 22 in the example of FIG. 3 which removes the satellites 34a from a suspended state in the region of air adjacent to media path 16. Other embodiments are possible, for example, where the source 42c emits positively charged ions and the source 42a emits negatively charged ions 43a. In some embodiments, an additional grounding structure 45b may be provided opposite of pen 30a as shown. In further example embodiments, grounded structures 45a, 45b may be implemented as a single continuous structure below media 22 as represented in phantom. In some arrangements, sufficient charge is present upon media 22 from source 42c and a power source to source 42a is not needed to emit ions 43a (e.g., source 42a may be implemented as a sharp edge or plural needles).

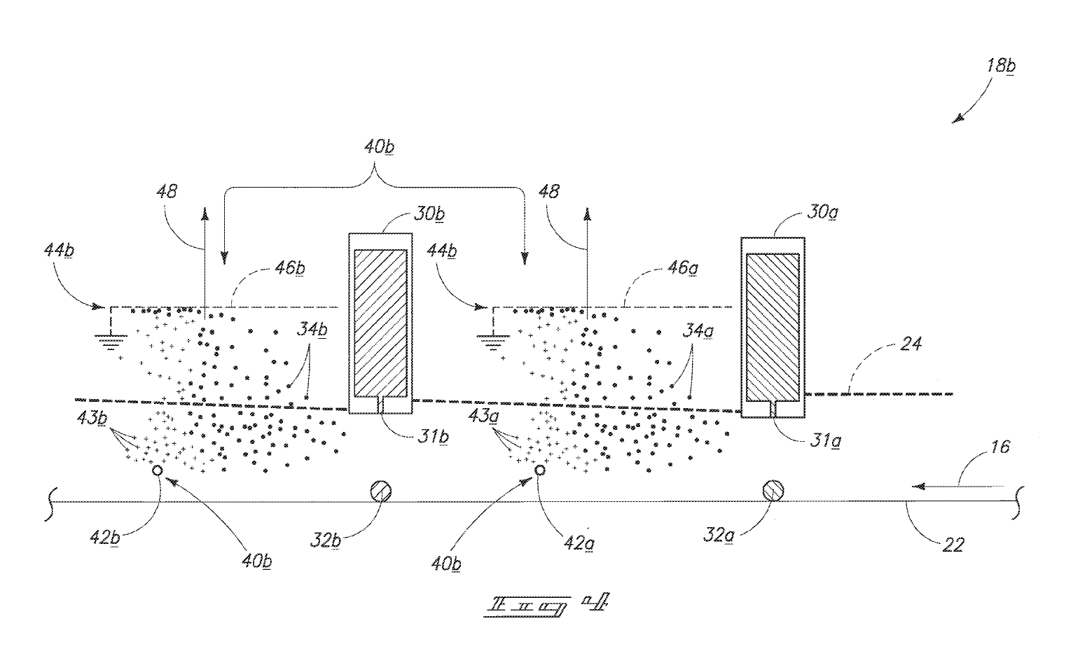

Referring to FIG. 4, another embodiment of print device 18b is shown. Print device 18b includes another embodiment of satellite removal system 40b configured to remove satellites 34a, 34b suspended in the air and resulting from the ejection of droplets 32a, 32b from nozzles 31a, 31b.

In the example embodiment of FIG. 4, satellite removal device 40b comprises a plurality of sources 42a, 42b which are configured to emit ions 43a, 43b of a common polarity (e.g., positively charged ions in the depicted example). Satellite removal device 40b also includes a plurality of collectors 46a, 46b which may be grounded to provide targets 44b for the positively-charged ions 43a, 43b and positively-charged satellites 34a, 34b. As shown in the example of FIG. 4, media 22 travelling along the media path 16 receives drops 32a, 32b of a liquid marking agent corresponding to an image being formed. Sources 42a, 42b are configured to emit the ions 43a, 43b which are attracted along field lines to the grounded collectors 46a, 46b. The ions 43a, 43b charge the satellites 34a, 34b which are subsequently also attracted to the collectors 46a, 46b to remove the suspended satellites 34a, 34b from a region of air adjacent to the media path 16. In other embodiments, sources 42a, 42b may emit negatively charged ions 43a, 43b which negatively charge the satellites 34a, 34b. Collectors 46a, 46b may be positively charged to attract the negatively charged ions 43a, 43b and satellites 34a, 34b.

The satellites 34a, 34b comprising liquid marking agent may collect at the collectors 46a, 46b. In one embodiment, the collectors 46a, 46b may individually comprise conductive grids and the satellites 46a, 46b may be collected upon the collectors 46a, 46b. In some arrangements, the satellite removal device 40b may remove liquid marking agent of the satellites 34a, 34b which has accumulated upon collectors 46a, 46b. In one embodiment, the collectors 46a, 46b may be heated to dry the liquid marking agent accumulated thereon to avoid the liquid marking agent from dripping upon the media 22 and to assist with evaporation of the liquid marking agent from the collectors 46a, 46b. Furthermore, a suction 48 may be provided for example by a vacuum in a direction upward and through collectors 46a, 46b to assist with removal of liquid marking agent from collectors 46a, 46b. The collectors 46a, 46b may be both heated and the suction 48 provided therethrough in some arrangements. In additional embodiments, the collectors 48a, 46b may be arranged vertically or in any other appropriate orientation to collect the satellites 34a, 34b.

The arrangement of FIG. 4 directs the satellites 34a, 34b upward away from the media 22 in the depicted embodiment. The arrangement of FIG. 4 may result in less unwanted background in the resulting hard images compared with the arrangements of FIGS. 2 and 3 since the satellites 42a, 42b are directed away from media 22.

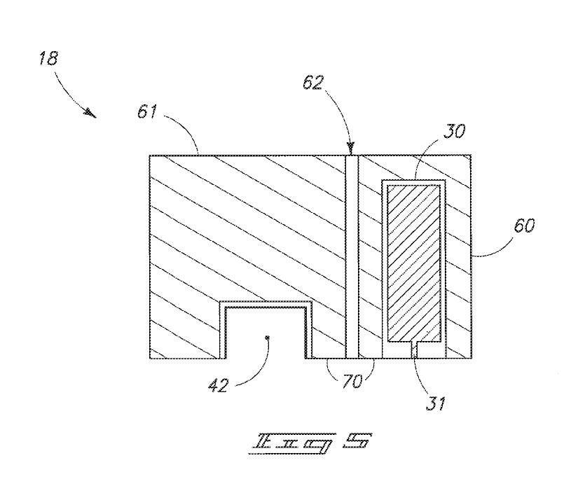

Referring to FIG. 5, one configuration of a print bar 60 of print device 18 is shown. The print bar 60 includes a housing 61 which houses pen 30 and source 42. The depicted configuration of print bar 60 illustrates one possible arrangement. In other embodiments, a plurality of rows of pens 30 and corresponding sources 42 may be provided in the print bar 60. The housing 61 of print, bar 60 includes a channel providing an air path 62. Movement of media 16 beneath print bar 60 draws a suction of air through air path 62 which draws satellites 30 away from pen 30 and from surface 70 between pen nozzle 31 and source 42 providing reduced accumulation of the liquid marking agent from the satellites 34 upon pen 30. Air path 62 has a diameter less than 1 mm in one embodiment.

At least some aspects of the disclosure describe methods and apparatus configured to remove satellites of liquid marking agent which are suspended in air in an imaging region adjacent to the print device. The removal of the satellites provides improved print quality during printing of numerous hard images compared with arrangements which do not remove satellites. In addition, utilization of an electrical field and charging of the satellites according to some of the example disclosed embodiments to remove the satellites may reduce or avoid a liquid marking agent from one of the pens cross-contaminating another of the pens (e.g., avoid or reduce a fixer from one pen contaminating a downstream ink pen in one example). Furthermore, the use of electrical fields to remove satellites does not affect hard images printed upon the media 22 compared with arrangements which rely upon suction to remove the satellites and which may alter hard images printed upon media. More specifically, a suction used to break the air boundary layer to remove suspended satellites may result in smearing of the hard images printed upon the media 22. At least some embodiments of the disclosure provide charging of satellites to direct the satellites through the boundary layer to the desired target without smearing hard images printed upon the media.

The protection sought is not to be limited to the disclosed embodiments, which are given by way of example only, but instead is to be limited only by the scope of the appended claims.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

1. A hard imaging device comprising:
a media transport system configured to move media along a media path;
a print device adjacent to the media path and configured to eject a plurality of droplets of a liquid marking agent in a direction towards the media moving along the media path to form hard images using the media, the ejection of the droplets of the liquid marking agent from the print device creates satellites of the liquid marking agent suspended in air in a region adjacent to the print device and the media; and
a satellite removal system configured to remove the satellites from the air in the region adjacent to the print device and the media.

2. The device of claim 1 wherein the print device comprises a first pen and a second pen arranged in series at different locations along the media path and configured to eject the droplets of the liquid marking agent comprising different colors, wherein the second pen is downstream of the first pen in a direction of movement of the media along the media path, and wherein the satellite removal system is configured to the remove the satellites, which resulted from the ejection of droplets of the liquid marking agent from the first pen, from the air before such satellites are adhered to the second pen.

3. The device of claim 1 wherein the satellite removal system comprises a charging device configured to electrically charge the satellites suspended in the air in the region adjacent to the print device and the media, and a target configured to attract the electrically charged satellites.

4. The device of claim 3 wherein the target comprises a conductive structure positioned adjacent to the media path to attract the electrically charged satellites to the media.

5. The device of claim 3 wherein the target comprises a conductive structure spaced from the media path to attract the electrically charged satellites away from the media.

6. The device of claim 1 wherein the print device comprises a nozzle configured to eject the droplets of the liquid marking agent, and the satellite removal system comprises:
a first charging device upstream of the nozzle and configured to provide an electrical charge of a first polarity to the media; and
a second charging device downstream of the nozzle and configured to provide an electrical charge of a second polarity to the satellites to cause the satellites to be attracted to the media.

7. The device of claim 1 wherein the print device comprises a pen configured to eject the droplets of the liquid marking agent and a housing comprising an air path configured to provide a flow of air to draw the satellites away from the pen during movement of the media along the media path.

8. A hard imaging device comprising:
a media transport system configured to move media along a media path;
a print device adjacent to the media path and configured to eject a plurality of droplets of a liquid marking agent in a direction towards the media moving along the media path;
a charging device configured to provide an electrical charge to satellites of the liquid marking agent suspended in air in a region adjacent to the print device and the media and which result from the ejection of the droplets of the liquid marking agent from the print device; and
a target configured to attract the satellites which have been electrically charged.

9. The device of claim 8 wherein the target is positioned to attract the satellites which have been electrically charged to the media.

10. The device of claim 8 wherein the target is positioned to attract the satellites which have been electrically charged away from the media path and the media.

11. The device of claim 8 wherein the charging device is configured to provide the electrical charge having a first polarity, and further comprising another charging device configured to provide an electrical charge of a second polarity to the media which comprises the target.

12. The device of claim 8 wherein the print device comprises a pen configured to eject the droplets of the liquid marking agent and a housing comprising an air path configured to provide a flow of air to draw the satellites away from the pen during movement of the media along the media path.

13. A hard imaging method comprising:
ejecting a plurality of droplets of a liquid marking agent in a direction towards media to from a hard image using the media, the ejecting the droplets suspending satellites of the liquid marking agent in air in a region adjacent to the media;
removing the satellites of the liquid marking agent from the air in the region adjacent to the media; and
receiving the droplets of the liquid marking agent upon the media to form the hard image comprising the droplets of the liquid marking agent and the media.

14. The method of claim 13 wherein the ejecting comprises ejecting the droplets comprising different colors of the liquid marking agent using a plurality of nozzles arranged in series in a process direction, and wherein the removing comprises removing the satellites having one of the colors of the liquid marking agent from the air in the region adjacent to a first of the nozzles prior to the satellites having the one of the colors being drawn into another region of air adjacent to a second of the nozzles downstream from the first of the nozzles.

15. The method of claim 13 wherein the removing comprises:
electrically charging the satellites suspended in the air; and
directing the electrically charged satellites to the media.

16. The method of claim 13 wherein the removing further comprises electrically charging the media to have a first polarity, and wherein the electrically charging the satellites comprises electrically charging the satellites to have a second polarity opposite to the first polarity, and the directing comprises directing the electrically charged satellites having the second polarity to the media having the first polarity.

17. The method of claim 13 wherein the removing comprises:
electrically charging the satellites suspended in the air; and
directing the electrically charged satellites away from the media.
